(19) United States
(12) Patent Application Publication
(10) Pub. No.: US 2004/0184705 A1
(43) Pub. Date: Sep. 23, 2004

(54) Optical waveguide component and method of manufacturing the same

(76) Inventors: Mikihiro Shimada, Osaka (JP); Masanori Iida, Osaka (JP)

Correspondence Address: RATNERPRESTIA, P O BOX 980, VALLEY FORGE, PA, 19482-0980, US

(21) Appl. No.: 10/752,830

(22) Filed: Jan. 7, 2004

(30) Foreign Application Priority Data
Jan. 8, 2003 (JP) 2003-002627

(51) Int. Cl. G02B 6/10

(52) U.S. Cl. 385/14; 385/132

(57) ABSTRACT

The present invention includes a light-transmissive first substrate having a first refractive index, a first groove for an optical waveguide, formed on the principal plane of said first substrate, filled with a material with a second refractive index which is higher than said first refractive index, a second groove, one end of which is formed on said principal plane of said first substrate at a predetermined distance from one end of said first groove, for placing an optical terminal on said first substrate and optically connecting said optical waveguide and said optical terminal, and a second substrate having a lower refractive index than said second refractive index placed on said first substrate for covering said first groove and at least part of said predetermined gap.

### BACKGROUND OF THE INVENTION

1. Field of the Invention

The present invention relates to an optical waveguide component principally used for optical communication, etc., and a method of manufacturing the same.

2. Related Art of the Invention

In recent years, an optical communication system using optical communication with broadband characteristics and having functions such as multiple-wavelength transmission and bidirectional transmission is becoming widespread in public communications and computer networks, etc., aiming at speed enhancement and performance enhancement.

In the field of optical communication, there is considerable ongoing research on an optical integrated circuit having various functions for high-level optical signal processing. The optical integrated circuit uses an optical waveguide as a basic element and the optical waveguide covers a core area of a high refractive index with cladding layers of a relatively low refractive index and thereby allows light trapped in the core area to propagate, and realizes various functions with patterned and arranged cores.

A typical method of manufacturing an optical waveguide uses a flame hydrolysis deposition as the method of forming core/cladding films and uses a reactive ion etching method as the method of forming a core pattern. As the method of forming a core/cladding, not only flame hydrolysis deposition but also a CVD method, vacuum deposition and sputtering method, etc., are proposed.

A quartz-based optical waveguide in particular has many merits such as a low loss characteristic, physical/chemical stability, quality of adjustment with an optical fiber, etc., and provides a typical passive optical waveguide.

Furthermore, to efficiently connect an optical waveguide and an optical fiber, there is also a case where an optical waveguide and optical fiber arrayed groove are formed on the same substrate (e.g., Japanese Patent Application Laid-Open No. 63-115113 (e.g., page 2, FIG. 1), the entire disclosure of which is incorporated herein by reference in its entirety).

However, such an optical waveguide has the following problems in aspects of cost and performance.

Suppressing optical losses between an optical fiber and optical waveguide in a single mode requires position adjustment at a level of ±1 μm or less, assembly and fixing. Furthermore, to manufacture an optical fiber arrayed groove, selective wet etching of a silicon substrate and a method of grinding various substrates are used, but these methods have defects of insufficient mass production capability and insufficient reproducibility of a groove shape.

Furthermore, as shown in FIG. 12, when using an optical waveguide 82 and an optical fiber arrayed groove 83 formed on a substrate 81, manufacturing the optical waveguide 82 makes it necessary to mold a groove corresponding to the optical waveguide 82 on the substrate 81, form the optical fiber arrayed groove 83 and process a groove 89 across the boundary of the optical wave guide 82 and the optical fiber arrayed groove 83, through machining, etc. This is because when resin which becomes the core of the optical waveguide is filled with the groove, it is necessary to allow the end face which faces the optical fiber arrayed groove 83 to be exposed to high accurately. The groove 89 may be cut and machined after the resin which becomes the core is filled with the groove corresponding to the waveguide 82 or may be cut and machined simultaneously with molding of the grooves corresponding to the optical fiber arrayed groove 83 and optical waveguide 82. At this time, however, when the resin which becomes the core is filled, it is necessary to place a provisional mold corresponding to the groove 89 to prevent resin from leaking from the end face.

Therefore, it is an actual situation that processing for finishing the end face of this optical waveguide is complicated resulting in a problem that this optical waveguide is unsuitable for mass production and it is difficult to reduce the cost.

In view of the above described problems of the conventional optical waveguide component, it is an object of the present invention to propose an optical waveguide component which satisfies performance, mass production capability and low cost simultaneously.

### SUMMARY OF THE INVENTION

The 1^{st} aspect of the present invention is an optical waveguide component comprising:

a light-transmissive first substrate having a first refractive index;

a first groove for an optical waveguide, formed on the principal plane of said first substrate, filled with a material with a second refractive index which is higher than said first refractive index;

a second groove, one end of which is formed on said principal plane of said first substrate at a predetermined distance from one end of said first groove, for placing an optical terminal on said first substrate and optically connecting said optical waveguide and said optical terminal; and

a second substrate having a lower refractive index than said second refractive index placed on said first substrate for covering said first groove and at least part of said predetermined gap.

The 2^{nd} aspect of the present invention is the optical waveguide component according to the 1^{st} aspect of the present invention, wherein the size of said predetermined gap is such a level that coupling efficiency between said optical waveguide and said optical terminal is substantially negligible.

The 3^{rd} aspect of the present invention is the optical waveguide component according to the 2^{nd} aspects of the present invention, wherein the size of said predetermined gap is such a size that said coupling efficiency is substantially 0.3 dB or less.

The 4^{th} aspect of the present invention is the optical waveguide component according to the 2^{nd} aspect of the present invention, having a relationship:

$$η = \frac{4}{{( \frac{{ω}_{1}}{{ω}_{2}} + \frac{{ω}_{2}}{{ω}_{1}} )}^{2} + {( \frac{λ}{π {ω}_{1} {ω}_{2}} \frac{d}{{n}_{1}} )}^{2}} \qquad ( Expression 1 )$$

where d is the value of the size of said predetermined gap, n1 is the refractive index of said first substrate, ω1 is the spot size of said optical waveguide, ω2 is the spot size of said optical terminal, λ is the wavelength of light that is guided through said optical waveguide and said optical terminal and η is the coupling efficiency between said optical waveguide and said optical terminal.

The 5^{th} aspect of the present invention is the optical waveguide component according to the 2^{nd} aspect of the present invention, wherein the end face at said one end of said first groove is inclined with respect to the optical axis of said optical waveguide.

The 6^{th} aspect of the present invention is the optical waveguide component according to the 2^{nd} aspect of the present invention, wherein the end face at said one end of said first groove is convexly curved viewed from the end face at said one end of said second groove.

The 7^{th} aspect of the present invention is the optical waveguide component according to the 6^{th} aspect of the present invention, wherein having a relationship:

$$\begin{matrix}η = \frac{4}{{( \frac{{ω}_{0}}{{ω}_{2}} + \frac{{ω}_{2}}{{ω}_{0}} )}^{2} + {( \frac{λ}{π {ω}_{0} {ω}_{2}} \frac{\vert d - {d}_{0} \vert}{n} )}^{2}} & ( Expression 2 ) \\ {d}_{0} = \frac{\begin{matrix}{( \frac{{πω}_{1}^{2}}{λ} )}^{2} ( \frac{{n}_{2} - {n}_{1}}{{n}_{1}} \frac{1}{R} ) - \\ \frac{{n}_{1}}{{n}_{2}} ( R - \sqrt{{R}^{2} - {ω}_{1}^{2}} ) ( 1 - \frac{{n}_{2} - {n}_{1}}{{n}_{2}} \frac{R - \sqrt{{R}^{2} - {ω}_{1}^{2}}}{R} )\end{matrix}}{\sqrt{\begin{matrix}{( \frac{{πω}_{1}^{2}}{λ} )}^{2} {( \frac{{n}_{1} - {n}_{2}}{{n}_{1}} \frac{1}{R} )}^{2} + \\ {( 1 + \frac{{n}_{1} - {n}_{2}}{{n}_{2}} \frac{R - \sqrt{{R}^{2} - {ω}_{1}^{2}}}{R} )}^{2}\end{matrix}}} & ( Expression 3 ) \\ {ω}_{0} = \frac{{ω}_{0}}{\sqrt{\begin{matrix}{( \frac{{πω}_{1}^{2}}{λ} )}^{2} {( \frac{{n}_{2} - {n}_{1}}{{n}_{1}} \frac{1}{R} )}^{2} + \\ {( 1 + \frac{{n}_{1} - {n}_{2}}{{n}_{2}} \frac{R - \sqrt{{R}^{2} - {ω}_{1}^{2}}}{R} )}^{2}\end{matrix}}} & ( Expression 4 )\end{matrix}$$

where d is the value of the size of said predetermined gap, n2 is the refractive index of said first substrate, ω1 is the spot size of said optical waveguide, ω2 is the spot size of said optical terminal, λ is the wavelength of light that is guided through said optical waveguide and said optical terminal, R is the radius of curvature of said convex-shaped curvature and η is the coupling efficiency between said optical waveguide and said optical terminal.

The 8^{th} aspect of the present invention is the optical waveguide component according to the 7^{th} aspect of the present invention, wherein the size of said predetermined gap is substantially 52 μm or less.

The 9^{th} aspect of the present invention is the optical waveguide component according to the 8^{th} aspect of the present invention, wherein said radius of curvature is substantially larger than 5 and smaller than 15.

The 10^{th} aspect of the present invention is the optical waveguide component according to the 2^{nd} aspect of the present invention, wherein an optical semiconductor element is mounted at the other end of said first groove.

The 11^{th} aspect of the present invention is an optical device comprising the optical waveguide component according to any one of the 1^{st} to the 10^{th} aspects of the present invention.

The 12^{th} aspect of the present invention is a method of manufacturing an optical waveguide component comprising:

a step of forming a first groove on the principle plane of a light-transmissive first substrate having a first refractive index;

a step of forming a second groove on said principle plane of said first substrate in such a way that one end thereof is placed at a predetermined distance from one end of said first groove;

a step of charging a material having a second refractive index higher than said first refractive index into said first groove and forming an optical waveguide; and

a step of covering at least part of said predetermined distance from said first groove and placing a second substrate having a refractive index lower than said second refractive index on said first substrate.

The 13^{th} aspect of the present invention is the method of manufacturing an optical waveguide component according to the 12^{th} aspect of the present invention, wherein said step of forming the first groove and said step of forming the second groove are performed through batch molding using a metal die.

### BRIEF DESCRIPTION OF THE DRAWINGS

FIG. 1 illustrates an optical waveguide component according to Embodiment 1 of the present invention;

FIG. 2 illustrates a metal die according to Embodiment 1 of the present invention;

FIG. 3 illustrates the waveguide part according to Embodiment 1 of the present invention;

FIG. 4 illustrates an optical fiber array according to Embodiment 1 of the present invention;

FIG. 5 is a plan view of the optical waveguide component according to Embodiment 1 of the present invention;

FIG. 6 illustrates a preferable condition of the optical waveguide component according to Embodiment 1 of the present invention;

FIG. 7 illustrates the optical waveguide component according to Embodiment 1 of the present invention;

FIG. 8 illustrates the optical waveguide component according to Embodiment 1 of the present invention;

FIG. 9 is a plan view of the optical waveguide component according to Embodiment 1 of the present invention;

FIG. 10 illustrates a preferable condition of the optical waveguide component according to Embodiment 1 of the present invention;

FIG. 11 illustrates an optical waveguide component according to Embodiment 2 of the present invention; and

FIG. 12 illustrates a conventional optical waveguide component.

### DESCRIPTION OF SYMBOLS

11, 71, 81 Substrate

12, 72 Optical waveguide groove

82 Optical waveguide

13, 73 Optical fiber arrayed groove

24 Metal die

35, 75 High refractive index material

36, 76 Second substrate

47 Optical fiber

78 Optical semiconductor element mounting section

79 Optical semiconductor element

89 Groove

### PREFERRED EMBODIMENTS OF THE INVENTION

With reference now to the attached drawings, embodiments the present invention will be explained below. Parts assigned the same reference numerals in the drawings represent the same parts.

(Embodiment 1)

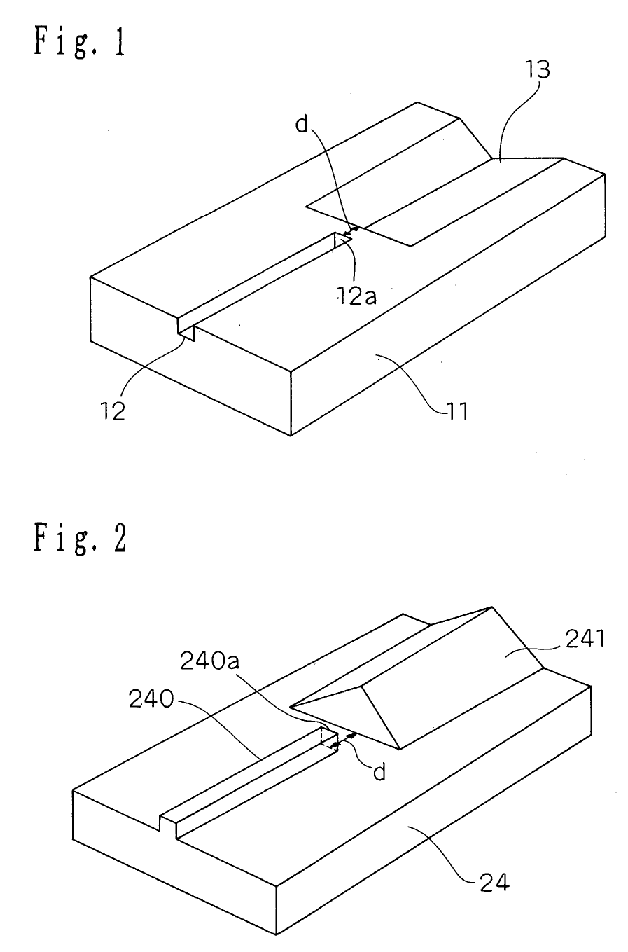

FIGS. 1 to 10 show a first embodiment of an optical waveguide component of the present invention and the optical waveguide component and method of manufacturing the optical waveguide component according to this embodiment of the present invention will be explained using these figures.

First, as shown in FIG. 1, an optical waveguide groove 12 and an optical fiber arrayed groove 13 are formed all together by means of molding using a metal die 24 shown in FIG. 2 on the surface of a substrate 11 made of glass or transparent resin. Providing a gap d between a part 240 corresponding to the optical waveguide and a part 241 corresponding to the optical fiber arrayed groove on the metal die 24 makes processing of the metal die 24 easier. Furthermore, as shown in FIG. 1, it is possible to form the optical waveguide groove 12 and the optical fiber arrayed groove 13 through part of the substrate 11. At this time, since an end 240a of the part 240 can be molded accurately through dry etching, etc., the end 12a facing the optical fiber arrayed groove 13 has an end face with sufficient accuracy as the optical waveguide in the optical waveguide groove 12 molded through a transfer.

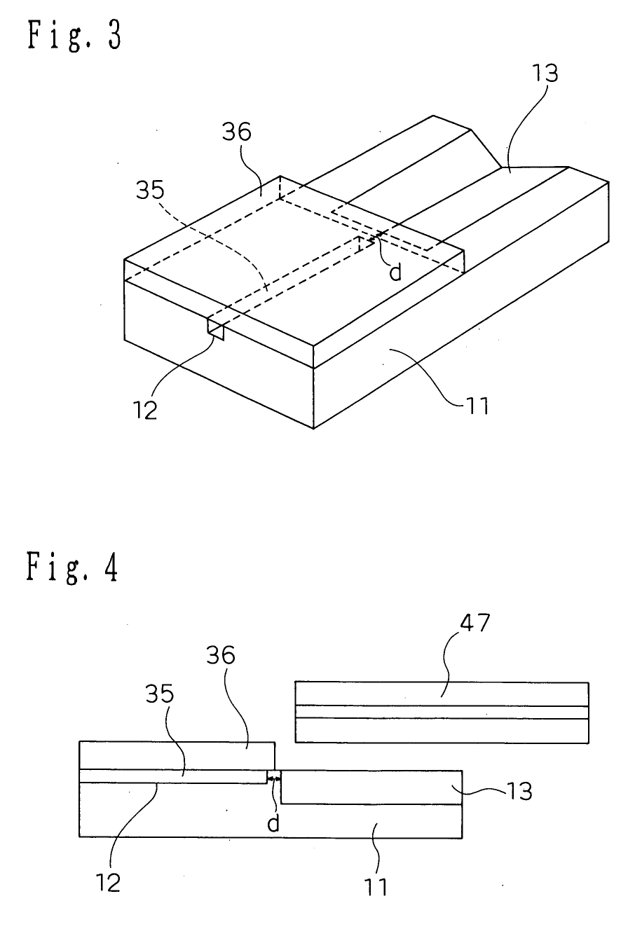

Then, as shown in FIG. 3, UV-cure resin is filled with the groove as a high refractive index material 35 where the optical waveguide groove 12 is formed and then a second substrate 36 is pasted thereto. The UV-cure resin in the groove is cured through irradiation with UV rays. Using UV-cure resin with a higher refractive index than those of the substrate 31 and second substrate 36 causes the UV-cure resin in the groove to function as an optical waveguide core. Leaving part of the substrate 31 as the gap d between the optical waveguide groove 12 and optical fiber arrayed groove 13 allows the dimensional accuracy to be relaxed by the gap d when the second substrate 36 is pasted. It goes without saying that the length of the second substrate 36 in the direction of the optical waveguide groove 12 can also have the same accuracy as that of the length of the high refractive index material 35 and the gap d. The second substrate 36 needs to be placed in such a way that the optical waveguide groove 12 is at least covered completely so as to prevent the high refractive index material 35 from being exposed to the outside.

Furthermore, as shown in FIG. 4, by placing an optical fiber 47 in the optical fiber arrayed groove 13, it is possible to facilitate alignment between the completed optical waveguide and the optical fiber 47 with high accuracy.

Then, with reference to FIG. 5, the relationship between the gap between the optical waveguide groove 12 and the optical fiber arrayed groove 13 and coupling efficiency will be explained.

FIG. 5 is a plan view showing the optical fiber 47 placed in the optical fiber arrayed groove 13. At this time, suppose that the refractive index of the first substrate is n1, the spot size of an optical waveguide 50 formed of the high refractive index material 35, second substrate 36 and optical waveguide groove 12 is ω1, the spot size of the optical fiber 47 is ω2, the wavelength of the waveguide light which propagates through the optical waveguide 50 and optical fiber 47 is λ and the coupling efficiency between the optical waveguide 50 and optical fiber 47 is η. Then, there is a relationship among these parameters including the gap d as shown below:

$$η = \frac{4}{{( \frac{{ω}_{1}}{{ω}_{2}} + \frac{{ω}_{2}}{{ω}_{1}} )}^{2} + {( \frac{λ}{π {ω}_{1} {ω}_{2}} \frac{d}{{n}_{1}} )}^{2}} \qquad ( Expression 1 )$$

Here, the spot size is a radius where the optical power inside the optical fiber 47 and optical waveguide 50 becomes e⁻².

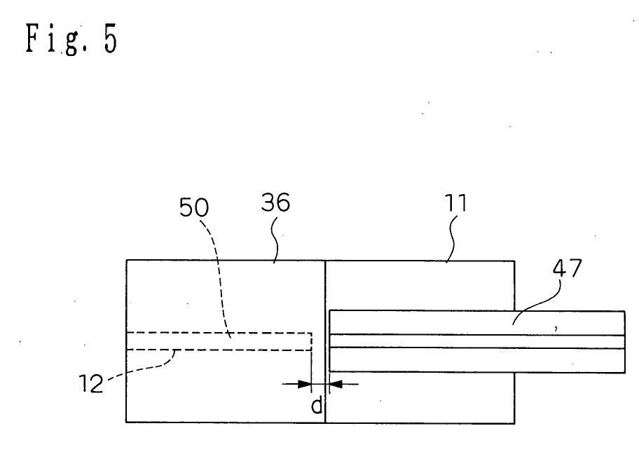

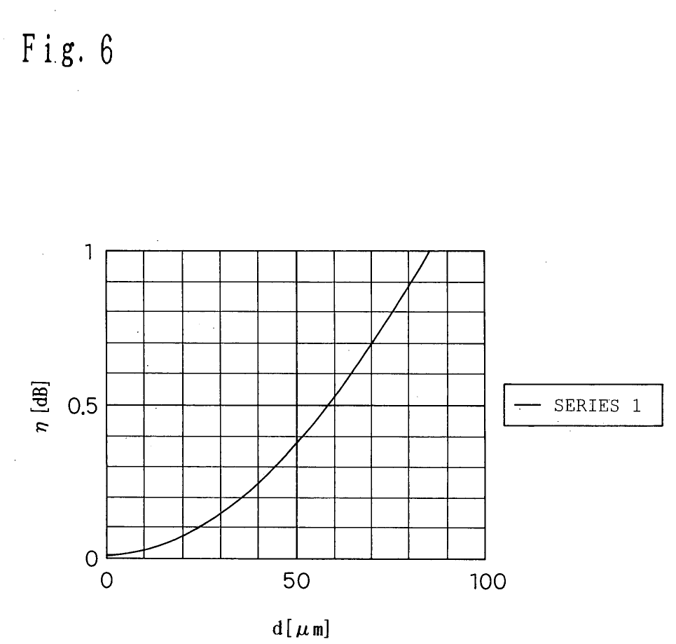

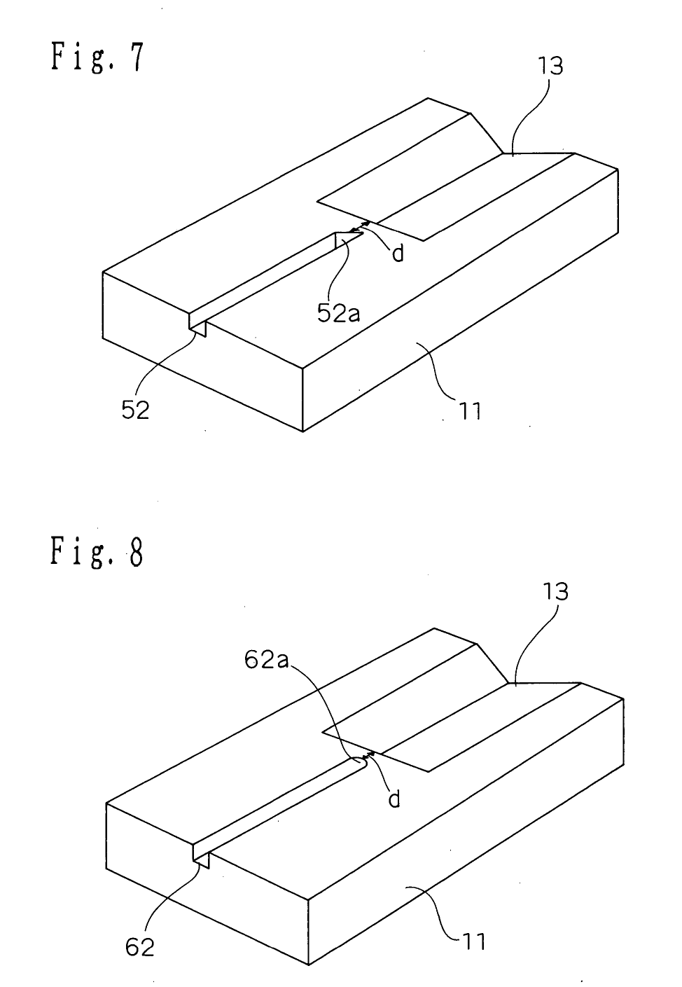

As shown in (Expression 1) above, in this embodiment, the refractive index of the substrate and the wavelength of the waveguide light are determined within a certain range with reference to technological common sense, and therefore the coupling efficiency η may be considered to be set principally by adjusting the gap d. FIG. 6 shows a graph assuming that the refractive index n1 of the first substrate is 1.49, the wavelength λ of the waveguide light is 1310 nm, spot size ω1 of the optical waveguide 50 is 5 μm, the spot size ω2 of the optical fiber 47 is fixed to 4.75 μm and the coupling efficiency η is expressed as a function of the gap d.

As shown in the figure, as the gap d increases the coupling efficiency η drastically deteriorates, while the gap d decreases the degree of deterioration decreases. For example, when the gap d is 45 μm, the coupling efficiency of approximately 0.3 dB can be secured and it is desirable to take a value equal to or smaller than this value as the gap d.

It is desirable to form the optical waveguide groove 12 and optical fiber arrayed groove 13 by means of molding from the standpoint of production as described in this embodiment, but the present invention is not limited to this and these parts can also be formed by etching or machining as required. Furthermore, the optical fiber arrayed groove 13 has been explained using a shape with a V-shaped cross section as an example, but the present invention is not limited to this and the cross sectional shape can also be trapezoidal, rectangular or semi-circular if the accuracy of the position at which it contacts the optical fiber is at least secured.

In this embodiment, the optical waveguide is formed by charging UV-cure resin as the high refractive index material 35, but the present invention is not limited to this and it is also possible to use thermosetting resin or polyimide, etc., as the high refractive index material. The cladding layer can also be formed by spin coating.

This embodiment has been described using one rectilinear waveguide as an example, but the present invention is not limited to this and the present invention can also be applied to all types of generally used optical waveguides, and bending, branching or coupling of a light wave can also be controlled.

In this embodiment, an optical fiber is placed only one side of the optical waveguide, but the present invention is not limited to this and the optical fiber can also be placed on both sides of the optical waveguide. At this time, both ends of the optical waveguide groove are formed inside the substrate 11 and each end of the optical waveguide is placed so as to face the corresponding end of the optical fiber arrayed groove.

Furthermore, as shown in FIG. 7, it is also possible to construct an optical waveguide groove 52 whose end face 52a is machined to be diagonal with respect to the optical axis of the optical waveguide and this allows reflected returned light to be suppressed. At this time, the gap d is determined relative to the center of the end face which forms the slope.

Furthermore as shown FIG. 8, by constructing an optical waveguide groove 62 whose end face 62a is convexly curved when especially viewed from the optical fiber arrayed groove 13 side, it is possible to suppress spreading of the light emitted from the optical waveguide groove end face 62a and improve the coupling efficiency with respect to the optical fiber. This makes it possible to efficiently connect the light emitted from the optical waveguide to the optical fiber. The convexly curved shape may be the curved plane of a column or a convex lens shape.

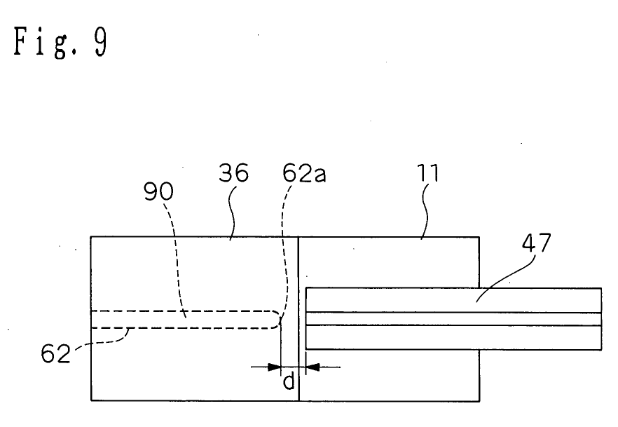

Here, with referenced to FIG. 9, the relationship between the distance between the optical waveguide groove 12 and optical fiber arrayed groove 13, and the coupling efficiency will be explained.

FIG. 9 is a plan view of an optical fiber 47 placed in the optical fiber arrayed groove 13. At this time, suppose that the refractive index of the first substrate is n2, the spot size of an optical waveguide 90 formed of a material equivalent to the high refractive index material 35, second substrate 36 and optical waveguide groove 62 is ω1, the spot size of the optical fiber 47 is ω2, the wavelength of the waveguide light which propagates through the optical waveguide and optical fiber 47 is λ and the coupling efficiency between the optical waveguide 90 and optical fiber 47 is η. Then, there is a relationship among these parameters including the gap d and the radius of curvature R of the end face 62a as follows:

$$η = \frac{4}{{( \frac{{ω}_{0}}{{ω}_{2}} + \frac{{ω}_{2}}{{ω}_{0}} )}^{2} + {( \frac{λ}{π {ω}_{0} {ω}_{2}} \frac{\vert d - {d}_{0} \vert}{n} )}^{2}} \qquad ( Expression 2 )$$

where there is a relationship between:

$$\begin{matrix}{d}_{0} = \frac{\begin{matrix}{( \frac{{πω}_{1}^{2}}{λ} )}^{2} ( \frac{{n}_{2} - {n}_{1}}{{n}_{1}} \frac{1}{R} ) - \\ \frac{{n}_{1}}{{n}_{2}} ( R - \sqrt{{R}^{2} - {ω}_{1}^{2}} ) ( 1 - \frac{{n}_{2} - {n}_{1}}{{n}_{2}} \frac{R - \sqrt{{R}^{2} - {ω}_{1}^{2}}}{R} )\end{matrix}}{\sqrt{\begin{matrix}{( \frac{{πω}_{1}^{2}}{λ} )}^{2} {( \frac{{n}_{1} - {n}_{2}}{{n}_{1}} \frac{1}{R} )}^{2} + \\ {( 1 + \frac{{n}_{1} - {n}_{2}}{{n}_{2}} \frac{R - \sqrt{{R}^{2} - {ω}_{1}^{2}}}{R} )}^{2}\end{matrix}}} \\ and & ( Expression 3 ) \\ {ω}_{0} = \frac{{ω}_{0}}{\sqrt{\begin{matrix}{( \frac{{πω}_{1}^{2}}{λ} )}^{2} {( \frac{{n}_{2} - {n}_{1}}{{n}_{1}} \frac{1}{R} )}^{2} + \\ {( 1 + \frac{{n}_{1} - {n}_{2}}{{n}_{2}} \frac{R - \sqrt{{R}^{2} - {ω}_{1}^{2}}}{R} )}^{2}\end{matrix}}} & ( Expression 4 )\end{matrix}$$

Here, the meaning of the spot size is the same as that shown in FIG. 5 and d0 denotes a distance up to the focal position and ω0 denotes the beam diameter at the focal position.

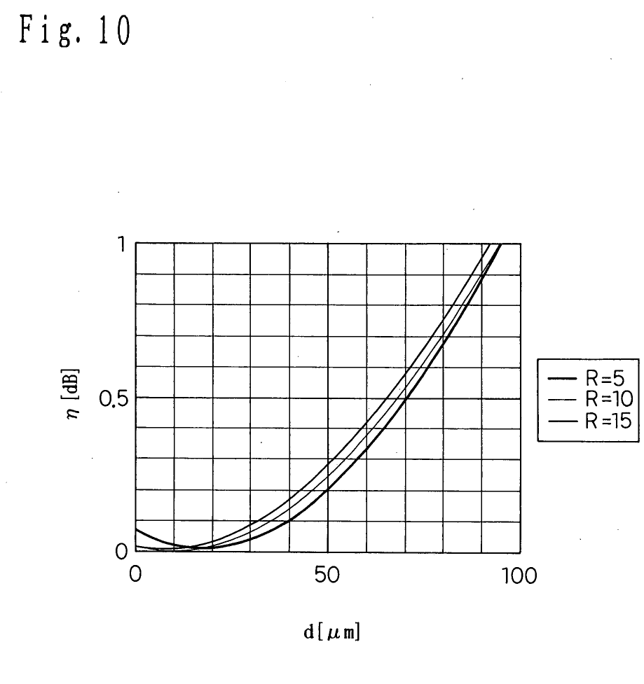

As in the case of the example shown in FIG. 5, in this embodiment, the refractive index of the substrate and the wavelength of the waveguide light are determined within a certain range with reference to technological common sense, and therefore the coupling efficiency η may be considered to be set principally by adjusting the gap d and the radius of curvature R of the end face 62a. The FIG. 10 shows a graph assuming that the refractive index n1 of the first substrate is 1.49, the wavelength λ of the waveguide light is 1310 nm, spot size ω1 of the optical waveguide 90 is 5 μm, the spot size ω2 of the optical fiber 47 is fixed to 4.75 μm and the coupling efficiency η is expressed as a function of the gap d and radius of curvature R. The graph shows three curves corresponding to the radius of curvature R=5, 10 and 15.

As shown in the FIG. 10, the coupling efficiency η deteriorates drastically as the gap d increases, but due to the curvature of the end face 62a, the coupling efficiency η deteriorates again when the gap d falls below a certain level. That is, the optimum coupling efficiency η is determined when the focal length matches the gap d when the end face 64 a functions as a lens and this case is different from the example in FIG. 5 in that when η is regarded as a function of d and R, it is given as a minimum value. As in the case of the example in FIG. 5, if the optimum coupling efficiency η is decided to be 0.3 dB or less, it is apparent that adjusting the gap d to substantially 52 μm or less allows a preferable result to be obtained irrespective of the radius of curvature.

On the other hand, if a smaller radius of curvature R is used, it is possible to obtain a good coupling efficiency even when a greater gap d than the above described value is adopted. When R=10, the gap d can be increased until substantially 55 μm and when R=5, the gap d can be increased until substantially 58 μm.

Furthermore, the optimum coupling efficiency η of substantially close to 0 is obtained when the radius of curvature R is 5 and gap d is substantially 16 to 20 μm, when the radius of curvature R is 10 and gap d is substantially 5 to 15 μm and when the radius of curvature R is 15 and gap d is substantially 5 to 10 μm, and ideally it is preferable to set the end face 64a and gap d to these values.

(Embodiment 2)

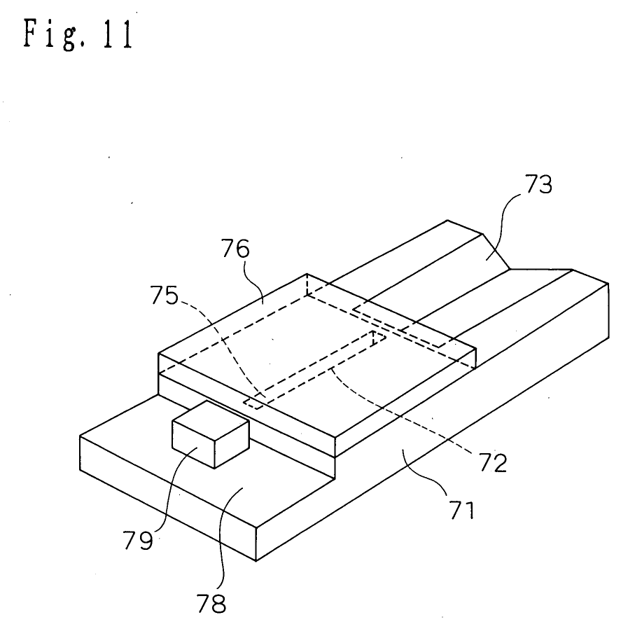

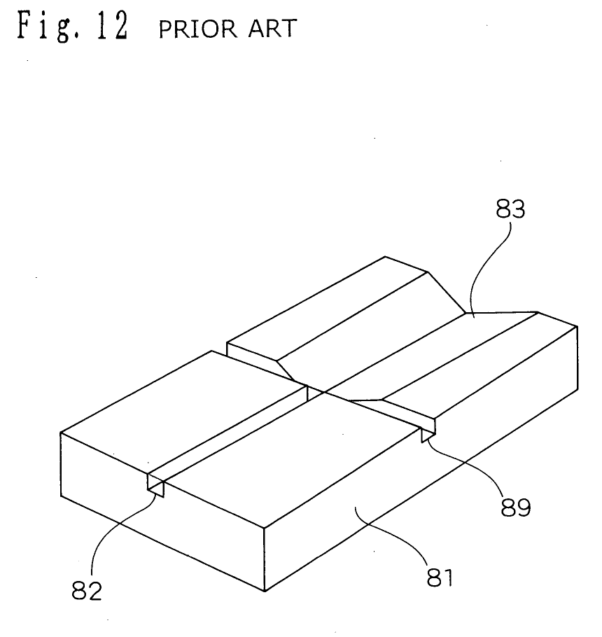

FIG. 11 shows a second embodiment of a waveguide part of the present invention and the waveguide part and method of manufacturing the waveguide part according to this embodiment of the present invention will be explained using this figure.

First, an optical waveguide groove 72, optical fiber arrayed groove 73 and an optical semiconductor element mounting section 78 are formed all together on the surface of a substrate 71 made of glass or transparent resin by means of molding using a metal die (not shown).

Then, UV-cure resin is filled with an optical waveguide groove 72 as a high refractive index material 75 and then a second substrate 76 is pasted thereto. The UV-cure resin in the groove is cured through irradiation with UV rays. Using UV-cure resin with a higher refractive index than those of the substrate 71 and second substrate 76 causes the UV-cure resin in the groove to function as the optical waveguide core. The above operation is the same as that in Embodiment 1.

Furthermore, placing the optical semiconductor element 79 on the optical semiconductor element mounting section 78 of the substrate 71 easily allows high accuracy alignment between the optical waveguide, optical fiber and optical semiconductor element.

As explained in this embodiment, it is preferable from the standpoint of production to form the optical waveguide, optical fiber arrayed groove and optical semiconductor element mounting section by means of molding, but the present invention is not limited to this and it is also possible to form those components by etching or machining.

Furthermore, the V-shaped optical fiber arrayed groove has been explained as an example, but the present invention is not limited to this and the shape of the optical fiber arrayed groove can also be trapezoidal, rectangular or semi-circular if it at least secures the accuracy of the position of contact with the optical fiber.

In this embodiment, the optical waveguide is formed by charging UV-cure resin as the high refractive index material, but the present invention is not limited to this and it is also possible to use thermosetting resin or polyimide, etc., as the high refractive index material. The cladding layer can also be formed by spin coating.

This embodiment has been described using one rectilinear waveguide as an example, but the present invention is not limited to this and the present invention can also be applied to all types of generally used optical waveguides, and bending, branching or coupling of a light wave can also be controlled.

Using glass as the substrate can improve the high-frequency characteristic of the substrate and realize transmission with low losses and also make it easier to secure reliability.

Furthermore, the present invention can also be an optical device provided with the above described optical waveguide component and examples of such a device include an optical transceiver and optical media converter.

In the above explanation, the substrates 11 and 71 correspond to the first substrate of the present invention, the optical waveguide grooves 12, 62 and 72 correspond to the first groove of the present invention, the optical fiber arrayed grooves 13 and 73 correspond to the second groove of the present invention, the optical waveguides 50 and 90 made up of the optical waveguide grooves 12, 62 and 72, second substrates 36 and 76 and high refractive index materials 35 and 75 correspond to the optical waveguide of the present invention, the second substrates 36 and 76 correspond to the second substrate of the present invention and the high refractive index materials 35 and 75 correspond to the material having the second refractive index of the present invention. Furthermore the gap d in the substrates 11 and 71 corresponds to a predetermined gap of the present invention.

Furthermore, the optical fiber 47 corresponds to the optical terminal of the present invention, but ferrule, etc. can also be used as another example of the optical terminal.

The optical waveguide component and the method of manufacturing the optical waveguide component according to the present invention can reduce manufacturing steps of the optical waveguide component and easily realize mass production at low cost and is useful as the optical waveguide component used for optical communication, etc.

What is claimed is:

1. An optical waveguide component comprising:
a light-transmissive first substrate having a first refractive index;
a first groove for an optical waveguide, formed on the principal plane of said first substrate, filled with a material with a second refractive index which is higher than said first refractive index;
a second groove, one end of which is formed on said principal plane of said first substrate at a predetermined distance from one end of said first groove, for placing an optical terminal on said first substrate and optically connecting said optical waveguide and said optical terminal; and
a second substrate having a lower refractive index than said second refractive index placed on said first substrate for covering said first groove and at least part of said predetermined gap.

2. The optical waveguide component according to claim 1, wherein the size of said predetermined gap is such a level that coupling efficiency between said optical waveguide and said optical terminal is substantially negligible.

3. The optical waveguide component according to claim 2, wherein the size of said predetermined gap is such a size that said coupling efficiency is substantially 0.3 dB or less.

4. The optical waveguide component according to claim 2, having a relationship:
$$η = \frac{4}{{( \frac{{ω}_{1}}{{ω}_{2}} + \frac{{ω}_{2}}{{ω}_{1}} )}^{2} + {( \frac{λ}{π {ω}_{1} {ω}_{2}} \frac{d}{{n}_{1}} )}^{2}} \qquad ( Expression 1 )$$
where d is the value of the size of said predetermined gap, n1 is the refractive index of said first substrate, ω1 is the spot size of said optical waveguide, ω2 is the spot size of said optical terminal, λ is the wavelength of light that is guided through said optical waveguide and said optical terminal and η is the coupling efficiency between said optical waveguide and said optical terminal.

5. The optical waveguide component according to claim 2, wherein the end face at said one end of said first groove is inclined with respect to the optical axis of said optical waveguide.

6. The optical waveguide component according to claim 2, wherein the end face at said one end of said first groove is convexly curved viewed from the end face at said one end of said second groove.

7. The optical waveguide component according to claim 6, wherein having a relationship:
$$\begin{matrix}η = \frac{4}{{( \frac{{ω}_{0}}{{ω}_{2}} + \frac{{ω}_{2}}{{ω}_{0}} )}^{2} + {( \frac{λ}{π {ω}_{0} {ω}_{2}} \frac{\vert d - {d}_{0} \vert}{n} )}^{2}} & ( Expression 2 ) \\ {d}_{0} = \frac{\begin{matrix}{( \frac{{πω}_{1}^{2}}{λ} )}^{2} ( \frac{{n}_{2} - {n}_{1}}{{n}_{1}} \frac{1}{R} ) - \\ \frac{{n}_{1}}{{n}_{2}} ( R - \sqrt{{R}^{2} - {ω}_{1}^{2}} ) ( 1 - \frac{{n}_{2} - {n}_{1}}{{n}_{2}} \frac{R - \sqrt{{R}^{2} - {ω}_{1}^{2}}}{R} )\end{matrix}}{\sqrt{\begin{matrix}{( \frac{{πω}_{1}^{2}}{λ} )}^{2} {( \frac{{n}_{1} - {n}_{2}}{{n}_{1}} \frac{1}{R} )}^{2} + \\ {( 1 + \frac{{n}_{1} - {n}_{2}}{{n}_{2}} \frac{R - \sqrt{{R}^{2} - {ω}_{1}^{2}}}{R} )}^{2}\end{matrix}}} & ( Expression 3 ) \\ {ω}_{0} = \frac{{ω}_{0}}{\sqrt{\begin{matrix}{( \frac{{πω}_{1}^{2}}{λ} )}^{2} {( \frac{{n}_{2} - {n}_{1}}{{n}_{1}} \frac{1}{R} )}^{2} + \\ {( 1 + \frac{{n}_{1} - {n}_{2}}{{n}_{2}} \frac{R - \sqrt{{R}^{2} - {ω}_{1}^{2}}}{R} )}^{2}\end{matrix}}} & ( Expression 4 )\end{matrix}$$
where d is the value of the size of said predetermined gap, n2 is the refractive index of said first substrate, ω1 is the spot size of said optical waveguide, ω2 is the spot size of said optical terminal, λ is the wavelength of light that is guided through said optical waveguide and said optical terminal, R is the radius of curvature of said convex-shaped curvature and η is the coupling efficiency between said optical waveguide and said optical terminal.

8. The optical waveguide component according to claim 7, wherein the size of said predetermined gap is substantially 52 μm or less.

9. The optical waveguide component according to claim 8, wherein said radius of curvature is substantially larger than 5 and smaller than 15.

10. The optical waveguide component according to claim 2, wherein an optical semiconductor element is mounted at the other end of said first groove.

11. An optical device comprising the optical waveguide component according to any one of claims 1 to 10.

12. A method of manufacturing an optical waveguide component comprising:
a step of forming a first groove on the principle plane of a light-transmissive first substrate having a first refractive index;
a step of forming a second groove on said principle plane of said first substrate in such a way that one end thereof is placed at a predetermined distance from one end of said first groove;
a step of charging a material having a second refractive index higher than said first refractive index into said first groove and forming an optical waveguide; and
a step of covering at least part of said predetermined distance from said first groove and placing a second substrate having a refractive index lower than said second refractive index on said first substrate.

13. The method of manufacturing an optical waveguide component according to claim 12, wherein said step of forming the first groove and said step of forming the second groove are performed through batch molding using a metal die.
